(19) United States
(12) Patent Application Publication
(10) Pub. No.: US 2026/0112115 A1
(43) Pub. Date: Apr. 23, 2026

(54) OCCLUSION DETECTION

(71) Applicant: QUALCOMM Incorporated, San Diego, CA (US)

(72) Inventors: Hazem Ahmed Mohamed Mohamed RASHED, Kronach (DE); Kiran BANGALORE RAVI, Paris (FR); Senthil Kumar YOGAMANI, San Diego, CA (US)

(21) Appl. No.: 18/920,699

(22) Filed: Oct. 18, 2024

(51) Int. Cl. G06T 17/20; G06T 7/20; G06V 10/25; G06V 10/26; G06V 20/70

(52) U.S. Cl. CPC G06T 17/20; G06T 7/20; G06V 10/25; G06V 10/26; G06V 20/70

(57) ABSTRACT

Systems and techniques are described herein for occlusion detection. For instance, a method for occlusion detection is provided. The method may include generating a plurality of voxels in a voxel space based on a point-cloud representation of a scene; generating an annotation point in the voxel space based on sensor data representative of an object in the scene; projecting a ray from a sensor position in the voxel space to the annotation point; and determining whether the annotation point is occluded based on the ray and the plurality of voxels.

### TECHNICAL FIELD

The present disclosure generally relates to perception based on sensor data. For example, aspects of the present disclosure include systems and techniques for detecting occlusions in sensor data.

### BACKGROUND

Occlusion detection and/or visibility detection refer to techniques to detect which regions of an image are occlusion boundaries and/or which regions of an image represent objects occluded by other objects. Visibility detection, occlusion detection, and/or occlusion reasoning includes the detection of whether a prediction (e.g., a bounding box based on a detected object) from perception stack (e.g., an object detector) is being occluded or blocked by another detected object or an unknown object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for occlusion detection. According to at least one example, a method is provided for occlusion detection. The method includes: generating a plurality of voxels in a voxel space based on a point-cloud representation of a scene; generating an annotation point in the voxel space based on sensor data representative of an object in the scene; projecting a ray from a sensor position in the voxel space to the annotation point; and determining whether the annotation point is occluded based on the ray and the plurality of voxels.

In another example, an apparatus for occlusion detection is provided that includes at least one memory and at least one processor (e.g., configured in circuitry) coupled to the at least one memory. The at least one processor configured to: generate a plurality of voxels in a voxel space based on a point-cloud representation of a scene; generate an annotation point in the voxel space based on sensor data representative of an object in the scene; project a ray from a sensor position in the voxel space to the annotation point; and determine whether the annotation point is occluded based on the ray and the plurality of voxels.

In another example, a non-transitory computer-readable medium is provided that has stored thereon instructions that, when executed by one or more processors, cause the one or more processors to: generate a plurality of voxels in a voxel space based on a point-cloud representation of a scene; generate an annotation point in the voxel space based on sensor data representative of an object in the scene; project a ray from a sensor position in the voxel space to the annotation point; and determine whether the annotation point is occluded based on the ray and the plurality of voxels.

In another example, an apparatus for occlusion detection is provided. The apparatus includes: means for generating a plurality of voxels in a voxel space based on a point-cloud representation of a scene; means for generating an annotation point in the voxel space based on sensor data representative of an object in the scene; means for projecting a ray from a sensor position in the voxel space to the annotation point; and means for determining whether the annotation point is occluded based on the ray and the plurality of voxels.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for determining occlusions, according to various aspects of the present disclosure;

FIG. 2 includes a 2D representation of a point-cloud representation of a scene;

FIG. 3 is a block diagram illustrating another example system for determining occlusions, according to various aspects of the present disclosure;

FIG. 4 is a block diagram illustrating yet another example system for determining occlusions, according to various aspects of the present disclosure;

FIG. 5 includes representation of an image of a portion of a scene including visible objects and occluded objects;

FIG. 6 is a block diagram illustrating an example implementation of an occlusion determiner, according to various aspects of the present disclosure;

FIG. 7 includes a representation of a ray between a first point and a second point through a number of unoccupied voxels;

FIG. 8 includes a representation of an image of portion of a scene including a visible object and an occluded object.

FIG. 9 is a block diagram illustrating yet another example system for determining occlusions, according to various aspects of the present disclosure;

FIG. 10 includes two representations of an image of scene, the scene including visible objects and occluded objects;

FIG. 11 is a flow diagram illustrating an example process for occlusion detection, in accordance with aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Occlusion detection, visibility detection, and/or occlusion reasoning refer to techniques to determine which regions of sensor data (e.g., an image) are occlusion boundaries and/or which regions of the sensor data represent objects occluded by other objects. Occlusion detection, visibility detection, and/or occlusion reasoning include the detection of whether a prediction (e.g., a bounding box based on a detected object) from perception stack (e.g., an object detector) is being occluded or blocked by another detected object or an unknown object. An auxiliary problem is to frequently output a measure of occlusion (e.g., a percentage of occlusion).

Occlusion detection, visibility detection, and/or occlusion reasoning may be used on outputs from any suitable object detector, such as any type of three-dimensional (3D) object detector. For example, a traffic-light detector, a traffic-sign detector, and a lane detector (among others) may detect objects. The detected objects may be analyzed by occlusion detection, visibility detection, and/or occlusion reasoning to determine a level of occlusion of the detected objects.

Occlusion reasoning is sensor agnostic. For example, occlusion reasoning may determine occlusion of objects based on sensor data (e.g., image data), point-cloud data from a point-cloud-capture system, such as light detection and ranging (LIDAR) data from a LIDAR system (including one or more LIDAR sensors), radio detection and ranging (RADAR) data from a RADAR system (including one or more RADAR sensors), and/or map data (e.g., a 3D map of static objects in a scene).

Given a set of annotations in a map of static objects, occlusion detection may transform such annotations into per-frame annotations which considers occlusions from dynamic objects. Occlusion detection may be used in the evaluation of quality of perception task outputs. For example, occlusion detection may be used to evaluate outputs of three-dimensional object detection (3DOD), traffic-light recognition (TLR), traffic-sign recognition (TSR) detection, lane detection and freespace extraction. For example, perception task quality is evaluated with and without occluded annotations to perform ablation studies on how deep neural networks (DNNs) detect objects under partial or large occlusions.

Systems, apparatuses, methods (also referred to as processes), and computer-readable media (collectively referred to herein as “systems and techniques”) are described herein for occlusion detection. For example, the systems and techniques described herein may determine a measure of geometric occlusion (e.g., how much of an object is blocked from line of sight of different sensors) from a viewpoint of one or more sensors (e.g., a camera, LIDAR sensor, RADAR sensor, etc.). For example, the systems and techniques may apply an approach to estimate a measure of occlusion across different perception outputs with different types of annotation primitives (e.g., bounding boxes, polylines, polygons, and/or meshes).

In some examples, the systems and techniques may obtain outputs from an autonomous vehicle (AV) perception sensor set (e.g., including multiple cameras, LIDAR systems, and/or RADAR systems) along with perception-system outputs for object detection (e.g., bounding boxes and/or 3D meshes) and/or lane detection (e.g., polylines and/or polygons). In some aspects, the systems and techniques may additionally obtain a map (e.g., a high-definition (HD) map) as input.

When perception tasks use multiple frames from the past to predict perception outputs (e.g., objects) from present and future frames, this leads to certain objects losing their line-of-sight status in one or more sensors (e.g., the objects are no longer within a field of view of the one or more sensors). The systems and techniques described herein can apply a geometric solution to evaluate a measure (e.g., a percentage) of surface(s) of one or more objects that are visible using multiple sensor systems (e.g., multiple cameras, LIDAR, and/or RADAR systems).

The systems and techniques may use one or more one-sweep point clouds per frame. One-sweep point clouds maintain occlusion information, as both dynamic and static objects are included. The point cloud has information about the full scene (e.g., including walls, buildings, cars, etc.). Additionally or alternatively, the systems and techniques may use one or more multi-sweep point clouds. Such multi-sweep point clouds may include both dynamic and static objects.

The systems and techniques may voxelize a point-cloud representation of the scene using a pre-defined voxel-size. Additionally or alternatively, the systems and techniques may generate voxels based on a map (e.g., an HD map) of the scene. The systems and techniques may project rays from a sensor towards annotation points of one or more annotations in a set of map data. The systems and techniques may trace the rays and determine if the rays hit an occupied voxel before reaching the queried annotation points. If an occupied voxel is reached first, then a queried annotation point (e.g., a queried annotation point of an annotation, such as bounding box), the queried annotation point can be marked as occluded.

For example, the systems and techniques may obtain a point cloud representation of a scene (e.g., generated by a LIDAR system or a RADAR system). The systems and techniques may voxelize the point cloud at a predetermined resolution. The predetermined resolution may be based on LIDAR, RADAR, and/or camera sensor parameters (e.g., extrinsic parameters and/or intrinsic parameters). Additionally or alternatively, the systems and techniques may obtain a map of the scene (e.g., an HD map) and generate a voxel representation of the map.

Additionally, the systems obtain annotations (e.g., outputs of detectors) and/or annotations of maps. In some aspects, the annotations may be 3D. For example, the annotations may be, or may include, bounding boxes (e.g., indicative of objects such as cars, pedestrians, traffic signs, traffic lights, etc.), polylines (e.g., indicative of lane boundaries), polygons (e.g., indicative of road marking such as crosswalks), and meshes (e.g., indicative of a road surface). In some aspects, the annotations may be projected into a two-dimensional (2D) image space. For example, the annotations may annotate images. Additionally or alternatively, the annotations may be obtained in the image space and may be unprojected the annotations into a 3D space, for example, the voxel space of the voxelized point cloud.

The systems and techniques may project (or cast) rays from a sensor location (in the voxel space) to points of the annotations (e.g., “annotation points”) in the voxel space. The systems and techniques may determine which rays intersect occupied voxels of the voxel space (e.g., occluded rays) and which reach the annotations without intersecting any occupied voxels (e.g., unoccluded rays). The occupancy of the voxels may be determined based on the point cloud and/or the map of the environment. The systems and techniques may use the rays to determine which points of the annotation are occluded and which are not. The systems and techniques may determine an occlusion score for an object in the scene based on a count of the occluded annotation points and unoccluded annotation points of the annotation corresponding to the object.

The systems and techniques may estimate, per sensor and per timestamp, geometrical estimates of levels of occlusion using voxel-based ray-tracing approaches, across multiple perception outputs (e.g., 3DOD, Lane polylines, traffic/construction polygonal objects, freespace boundaries). The geometric estimate of the percentage of occlusion may be performed based on the uniform sampling of the shape of the surface of the object represented by bounding boxes or polygons or polylines.

In some aspects, the systems and techniques can use optical flow and/or scene flow. For example, optical flow enables the detection of relative object movement and allows the systems and techniques to infer the absence of occlusion in camera sensors where there are very few points from point cloud sensors (e.g., LIDAR and/or RADAR sensors). Additionally, scene flow (e.g., LIDAR scene flow) enables the detection of object movement while checking of occlusion across multiple frames/point clouds.

Unlike other methods, the systems and techniques described herein consider a full scene and not only annotated boxes. Unlike other methods which work only for bounding boxes, the systems and techniques can work for any type of annotation.

In the present disclosure, various examples include vehicles. However, the systems and techniques are not limited to vehicle applications and can be applied to any other systems or applications, such as extended reality (XR) systems or applications, robotic systems or applications, among others.

Various aspects of the application will be described with respect to the figures below.

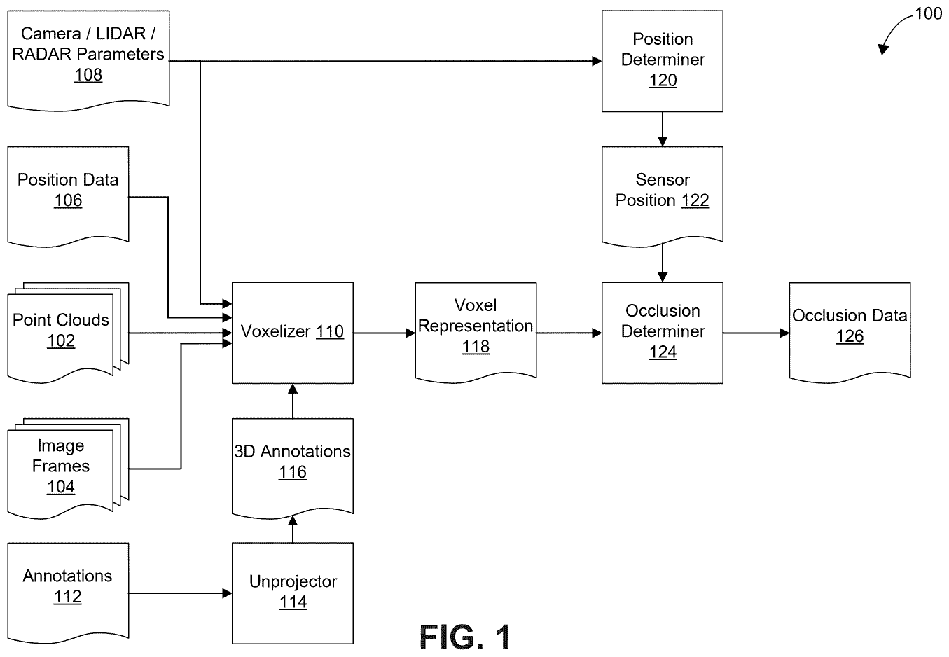

FIG. 1 is a block diagram illustrating an example system 100 for determining occlusions, according to various aspects of the present disclosure. In general, a voxelizer 110 may generate a voxel representation 118 of a scene based on position data 106, camera/LIDAR/RADAR parameters 108, and point clouds 102 and image frames 104 representative of the scene. Additionally, an unprojector 114 may generate 3D annotations 116 based on annotations 112 and voxelizer 110 may include 3D annotations 116 in voxel representation 118. A position determiner 120 may determine sensor position 122 based on camera/LIDAR/RADAR parameters 108. An occlusion determiner 124 may determine occlusion data 126 based on voxel representation 118 and sensor position 122.

Point clouds 102 may be, or may include, point-cloud representations of a scene. point clouds 102 may be, or may include, LIDAR captures from a LIDAR system and/or RADAR captures from a RADAR system. point clouds 102 may be, or may include, one-sweep captures including both static and dynamic objects.

Image frames 104 may be, or may include, images of the scene. Image frames 104 may include images of various views of the scene, for example an image captured in a first direction (e.g., by a first camera) and an image captured in a second direction (e.g., by a second camera).

Point clouds 102 and image frames 104 may represent the same scene. For example, point clouds 102 and image frames 104 may be captured of by respective LIDAR and imaging systems in the same scene. Additionally, point clouds 102 and image frames 104 may be captured at substantially the same time.

Point clouds 102 and image frames 104 may be captured by respective systems that are proximate to one another but not in the same position. For example, point clouds 102 may be captured by LIDAR system in a first position and image frames 104 may be captured by a camera in a second position. For instance, the LIDAR system and the camera may be positioned on a vehicle.

Position data 106 may be, or may include, data related to a position of a system that captured point clouds 102 and image frames 104. For example, position data 106 may be, or may include, coordinate (e.g., in a reference coordinate system, such as latitude and longitude).

Camera/LIDAR/RADAR parameters 108 may be, or may include, parameters of a system that captured point clouds 102 and a system that captured image frames 104. Camera/LIDAR/RADAR parameters 108 may be, or may include, extrinsic and intrinsic parameters of the camera, the LIDAR system, and/or the RADAR system. Camera/LIDAR/RADAR parameters 108 may include a position of the camera that captured image frames 104 relative to the LIDAR system that captured point clouds 102. For example, camera/LIDAR/RADAR parameters 108 may include a distance and direction between the LIDAR system and the camera.

Voxelizer 110 may voxelize a point-cloud representation of the scene (e.g., point clouds 102) to generate voxel representation 118. For example, voxelizer 110 may downsample point clouds 102 to store points of point clouds 102 in voxels of voxel representation 118. Voxelizer 110 may voxelize point clouds 102 into voxels of a predetermined resolution. The predetermined resolution may be based on LIDAR/Camera sensor reference/extrinsics.

In some aspects, voxelizer 110 may generate voxel representation 118 additionally based on a map (e.g., a high-definition (HD) map) of the scene. For example, voxelizer 110 may obtain a map (e.g., an HD map) of the environment (not illustrated in FIG. 1) represented by point clouds 102 and image frames 104. Voxelizer 110 may generate voxels based on the map and include the voxels in voxel representation 118.

Annotations 112 may be, or may include, 2D labels associated with pixels of an image of the scene. For example, annotations 112 may be based on image frames 104. For example, in some cases, a detector (e.g., an object detector) may generate annotations 112 based on image frames 104. Such 2D annotations may include pixel coordinates (e.g., relative to an image plane) and labels.

Additionally or alternatively, annotations 112 may be, or may include, 3D annotations, such as 3D bounding boxes, 3D polylines, 3D polygons, and/or 3D meshes. The 3D annotations may be based on map data. For example, a map (e.g., an HD map) may include a 3D mesh describing a road surface, and bounding boxes describing buildings. Additionally or alternatively, a 3D object detector may generate 3D annotations based on point clouds 102.

Bounding boxes of annotations 112 may be indicative of objects in the scene. Bounding boxes of annotations 112 may be indicative of pixels in images of the scene (e.g., image frames 104) that represent objects. The bounding boxes of annotations 112 may be 2D in an image plane of an image (e.g., of image frames 104) of the scene. Additionally or alternatively, the bounding boxes may be 3D (e.g., based on map data and/or point clouds 102). The bounding boxes of annotations 112 may represent objects such as people, pedestrians, cyclists, vehicles, traffic signs, traffic lights, animals, buildings, trees, etc.

Meshes of annotations 112 may be indicative of objects (e.g., surfaces) in the scene. Meshes of annotations 112 may be indicative of pixels in images of the scene (e.g., image frames 104) that represent objects. The meshes of annotations 112 may be 2D in an image plane of an image (e.g., of image frames 104) of the scene. Additionally or alternatively, the meshes may be 3D (e.g., based on map data and/or point clouds 102). The meshes of annotations 112 may represent surfaces, such as drivable surfaces including roads.

Polylines of annotations 112 may be indicative of objects (e.g., lines) in the scene. Polylines of annotations 112 may be indicative of pixels in images of the scene (e.g., image frames 104) that represent lines. The polylines of annotations 112 may be 2D in an image plane of an image (e.g., of image frames 104) of the scene. Additionally or alternatively, the polylines may be 3D (e.g., based on map data and/or point clouds 102). The polylines of annotations 112 may represent elements of a road, such as lane lines, lane boundaries, lane markings, curbs, sidewalks, shoulders, etc.

Polygons of annotations 112 may be indicative of objects (e.g., shapes) in the scene. Polygons of annotations 112 may be indicative of pixels in images of the scene (e.g., image frames 104) that represent shapes. The polygons of annotations 112 may be 2D in an image plane of an image (e.g., of image frames 104) of the scene. Additionally or alternatively, the polygons may be 3D (e.g., based on map data and/or point clouds 102). The polygons of annotations 112 may represent elements of a road, such as crosswalks, marked portions of a road, etc.

Unprojector 114 may unproject 2D annotations of annotations 112 to generate 3D annotations 116. In the present disclosure, the term “project” may be used to refer to a process of generating a 2D image or projection of an object based on a 3D representation of the object. For example, a 3D representation of an object may be projected onto a 2D image plane. In the present disclosure, the term “unproject” may be used to refer to a process of generating a 3D representation of an object based on a 2D image or projection of the object. For example, a 2D image of an object in an image plane may be unprojected into a 3D space to generate a 3D representation of the object.

3D annotations 116 may be, or may include, 3D representations in a 3D space including 3D annotations of annotations 112 and unprojected 2D annotations of annotations 112. The 2D annotations of annotations 112 including 2D bounding boxes, 2D polylines, 2D polygons, and 2D meshes in image planes (e.g., corresponding to image frames 104), may be unprojected into 3D annotations 116 including 3D bounding boxes, 3D polylines, 3D polygons and/or 3D meshes in a 3D space. The 3D space may relate to the 3D space represented by point clouds 102. For example, 3D annotations 116 may be positioned in point clouds 102 in positions corresponding to the positions of the objects, lines, and polygons represented by 3D annotations 116.

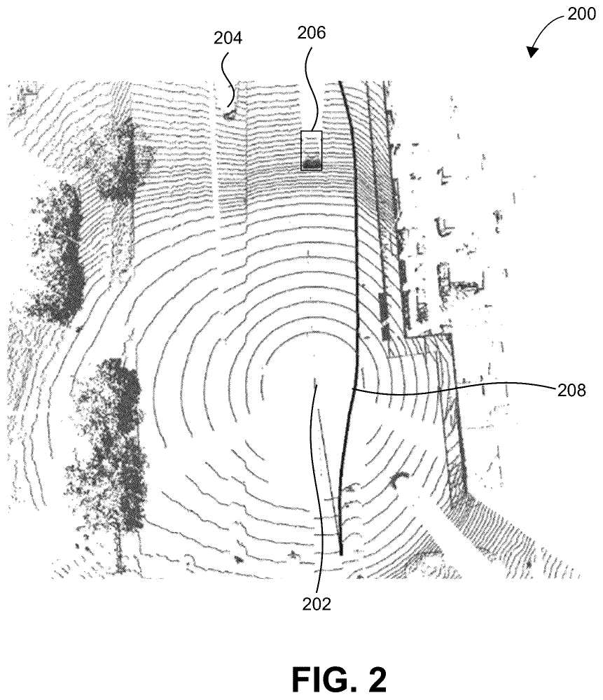

FIG. 2 includes a 2D representation 200 of a point-cloud representation of a scene. For example, 2D representation 200 may be a bird's-eye-view of the point-cloud representation of the scene, for example, flattening the height dimension of the point-cloud representation. The point cloud may be generated based on a LIDAR or RADAR capture from a position 202 in the scene. The point-cloud representations of the scene is an example of a one-sweep point cloud.

The scene may include an object 204 that is represented by points of the point cloud. Additionally, the scene may include an object that is annotated by bounding box 206. Additionally, the scene may include an object (e.g., a road boundary) annotated by polyline 208.

Returning to FIG. 1, voxelizer 110 may voxelize point clouds 102 to generate voxel representation 118. In the present disclosure, the term “voxelize” may be used to refer to a process of generating a plurality of voxels in a simulated 3D space based on 3D points in a 3D space. Voxels of voxel representation 118 may be “occupied” or “unoccupied” based on whether the voxels is generated based on a point of point clouds 102 or not. Voxelizing may be a process of spatially downsampling a 3D representation such as a point cloud.

Additionally, voxelizer 110 may obtain a map (e.g., an HD map) (not illustrated in FIG. 1) of scene and generate voxels for voxel representation 118 based on the map.

Voxelizer 110 may generate voxel representation 118 to include 3D annotations 116. For example, voxelizer 110 may position the 3D bounding boxes, 3D polylines, 3D polygons and/or 3D meshes in the 3D space of voxel representation 118.

Position determiner 120 may determine sensor position 122 based on camera/LIDAR/RADAR parameters 108. Sensor position 122 may represent a position of a sensor (or sensors) (e.g., a camera or cameras) that captured image frames 104 in the 3D space of point clouds 102 (and/or voxel representation 118) or the position of the RADAR/LIDAR system that captured point clouds 102.

Occlusion determiner 124 may generate occlusion data 126 which may indicate whether (and/or to what extent) various objects in the scene are occluded. For example, occlusion data 126 may indicate whether (and/or to what extent) a given object in a scene is visible to a sensor that capture image frames 104 and/or to a LIDAR or RADAR system that captured point clouds 102.

For example, occlusion determiner 124 may project (or cast) a number of rays from sensor position 122 to points of 3D annotations 116. In the present disclosure, the term “project” or “cast” may refer to a process of generating a ray between two points in a 3D space, where the ray may have an origin at a first point of the two points and a destination (or an end-point) at a second point of the two points. For example, occlusion determiner 124 may project or cast a ray from sensor position 122 (the origin) to a point of one of 3D annotations 116 (the destination).

Occlusion determiner 124 may determine which of the rays intersect occupied voxels of voxel representation 118 before reaching the points of 3D annotations 116 (e.g., occluded rays). Additionally, occlusion determiner 124 may determine which of the rays do not intersect occupied voxels before reaching the points of 3D annotations 116 (e.g., unoccluded rays). Occlusion determiner 124 may determine occlusion data 126 based on the rays. For example, occlusion determiner 124 may determine occlusion data 126 based on a relationship between a count of occluded rays and a count of unoccluded rays (e.g., the number of occluded rays divided by the total number of rays).

By determining occlusion data 126 based on rays, occlusion determiner 124 may determine occlusion data 126 according to a mathematical, repeatable process. In contrast, other occlusion-detection processes may determine occlusion in a heuristic fashion.

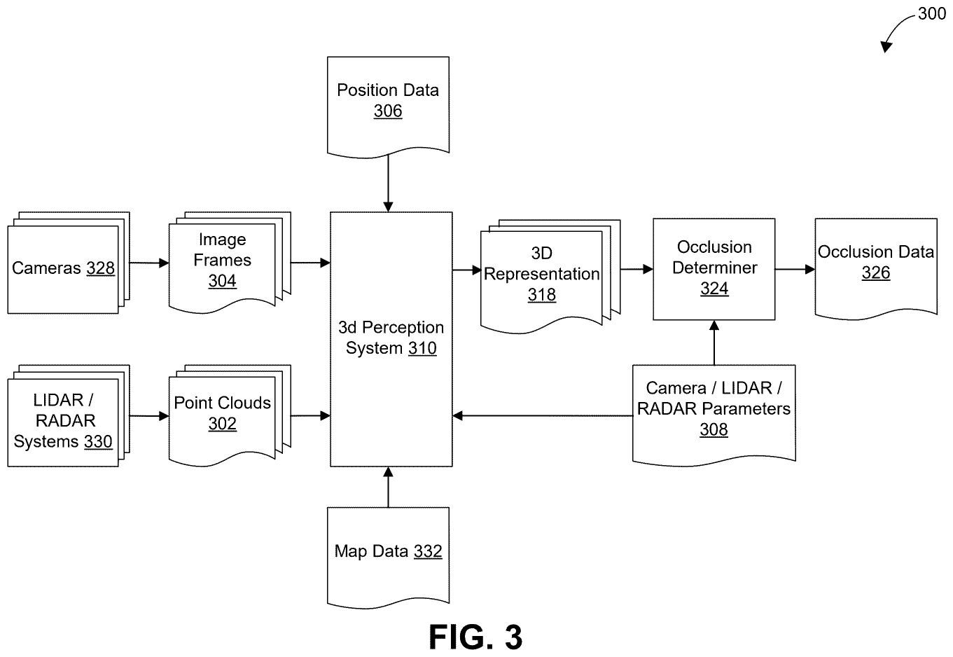

FIG. 3 is a block diagram illustrating an example system 300 for determining occlusions, according to various aspects of the present disclosure. In general, cameras 328 may capture image frames 304 of a scene. Additionally, LIDAR/RADAR systems 330 may capture point clouds 302 representative of the scene. 3D perception system 310 may generate a 3D representation 318 of the scene (including 3D representations of various objects in the scene) based on image frames 304, point clouds 302, position data 306, map data 332, and camera/LIDAR/RADAR parameters 308. An occlusion determiner 324 may determine occlusion data 326 based on 3D representation 318 and camera/LIDAR/RADAR parameters 308.

LIDAR/RADAR systems 330 may be, or may include, any suitable system for capturing a 3D representation of a scene. In some aspects, LIDAR/RADAR systems 330 may be, or may include, a LIDAR system. Additionally or alternatively, LIDAR/RADAR systems 330 may be, or may include, a RADAR system. LIDAR/RADAR systems 330 may capture point clouds 302. Point clouds 302 may include LIDAR captures from a number (e.g., m) of LIDAR/RADAR systems 330 for a number (e.g., q) of times (e.g., LIDARs(t) L1, L2, . . . . Lm, LIDARs(t−1) L1, L2, LM, . . . . LIDARs(t−q) L1, L2, . . . . Lm). Point clouds 302 may be the same as, or may be substantially similar to, point clouds 102 of FIG. 1.

Cameras 328 may be, or may include, any suitable system for capturing 2D representations (e.g., images) of the scene. In some aspects, cameras 328 may include a number of cameras, for example, facing a respective number of directions. Cameras 328 may be positioned proximate to LIDAR/RADAR systems 330. For example, cameras 328 and LIDAR/RADAR systems 330 may be positioned on a vehicle. Image frames 304 may include image frames from a number (e.g., k) of cameras 328 for a number (e.g., p) of times (e.g., Cameras(t) C1, C2, . . . . Ck, Cameras(t−1) C1, C2, . . . . Ck, . . . . Cameras(t−p) C1, C2, . . . . Ck). Image frames 304 may be the same as, or may be substantially similar to, image frames 104 of FIG. 1.

Position data 306 may be the same as, or may be substantially similar to, position data 106 of FIG. 1. Camera/LIDAR/RADAR parameters 308 may be the same as, or may be substantially similar to, camera/LIDAR/RADAR parameters 108 of FIG. 1.

Map data 332 may be, or may include, a 3D map of the scene (e.g., an HD map). Map data 332 may include 3D points representing road surfaces, buildings, traffic lights, traffic signs, lane markings, sidewalks, curbs, etc.

3D perception system 310 may generate 3D representation 318 based on point clouds 302, image frames 304, position data 306, camera/LIDAR/RADAR parameters 308, and map data 332. 3D representation 318 may be, or may include, a 3D representation the scene represented by image frames 304 and point clouds 302.

In some aspects, 3D perception system 310 may voxelize 3D representation 318 such that 3D representation 318 is a voxelized representation of the scene. For example, 3D representation 318 may include a number of voxels. Each of the voxels may be “occupied” or “unoccupied” based on whether point clouds 302 (and/or map data 332) includes a point within a space corresponding to the voxel.

Additionally, 3D representation 318 may include 3D annotations. For example, 3D perception system 310 may obtain 2D annotations of image frames 304 (e.g., determined by an object detector) and unproject the annotations into 3D representation 318. The 2D annotations may include bounding boxes, polylines, polygons, and/or meshes. 3D perception system 310 may unproject the 2D annotations into 3D representation 318 to generate 3D bounding boxes, polylines, polygons, and/or meshes.

Additionally or alternatively, the 3D annotations may be determined by a 3D object detector (e.g., based on point clouds 302) and/or be based on or included in map data 332. Such 3D annotations likewise may include generate 3D bounding boxes, polylines, polygons, and/or meshes.

3D perception system 310 may be the same as, may be substantially similar to, and/or may perform the same, or substantially the same, operations as voxelizer 110 of FIG. 1 3D representation 318 may be the same as, or may be substantially similar to, voxel representation 118 of FIG. 1.

Occlusion determiner 324 may determine occlusion data 326, which may be, or may include, indications of an extent to which objects annotated by the annotations are occluded by other objects in image frames 304, point clouds 302, and/or map data 332. Occlusion determiner 324 may be the same as, may be substantially similar to, and/or may perform the same, or substantially the same, operations as occlusion determiner 124 of FIG. 1. Occlusion data 326 may be the same as, or may be substantially similar to, occlusion data 126 of FIG. 1.

For example, occlusion determiner 324 may determine a position of cameras 328 (or a position of LIDAR/RADAR systems 330) in the 3D space of 3D representation 318 based on camera/LIDAR/RADAR parameters 308. Occlusion determiner 324 may determine a number of 3D points associated with the various objects annotated by the annotations. Occlusion determiner 324 may project (or cast) a number of rays from the position of cameras 328 (or the position of LIDAR/RADAR systems 330) to the points of the objects. Occlusion determiner 324 may determine, for each object, an occlusion score based on a count of the rays that reach the points of the object and based on a count of the rays that intersected occupied voxels of 3D representation 318 before reaching the points of the object.

For example, occlusion data 326 may include information such as the information provided in example table 1.

TABLE 1

| | | Polylines | Polygons and Meshes |
|---|---|---|---|
| | | (lanes, road | (trees, buildings, |
| | Bounding Boxes | boundaries, | traffic islands, |
| | (3DOD, TLR, TSR) | curbs, sidewalks) | poles, road surface) |
| Camera | 0 (no occlusions) | | 0.35 (tree polygon) |
| 1 (t) | | | 0.1 (road mesh) |
| Camera | 0.5 (traffic light | 0.25 (lane line | 0.35 (tree polygon) |
| 1 (t-1) | bounding box) | polyline) | 0.2 (road mesh) |
| Camera | | | |
| 1 (t-p) | | | |
| Camera | | | |
| 2 (t) | | | |
| Camera | | | |
| 2 (t-1) | | | |
| Camera | | | |
| 2 (t-p) | | | |
| LIDAR | | | |
| 1 (t) | | | |
| LIDAR | | 0.25 (lane line | |
| 1 (t-1) | | polyline) | |
| LIDAR | | | |
| 1 (t-q) | | | |
| LIDAR | | | |
| 2 (t) | | | |
| LIDAR | | | |
| 2 (t-1) | | | |
| LIDAR | | | |
| 2 (t-q) | | | |

Table 1 is provided as an example. Table 1 includes objects associated with annotations (e.g., bounding boxes, polylines, polygons, and/or meshes that represent the objects). Table 1 includes occlusion scores (e.g., percentages of occlusion) for objects as viewed from various cameras, and/or LIDAR/RADAR systems.

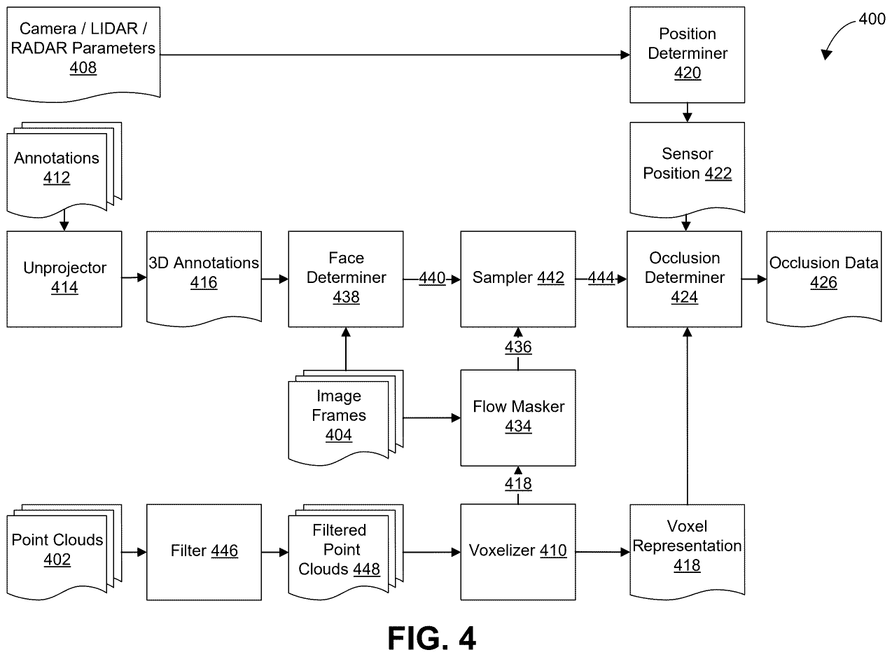

FIG. 4 is a block diagram illustrating an example system 400 for determining occlusions, according to various aspects of the present disclosure. In general, a filter 446 may filter various points of point clouds 402 (which are representative of a scene) to generate filtered point clouds 448. A voxelizer 410 may generate a voxel representation 418 of the scene based on filtered point clouds 448. A flow masker 434 may generate a masks 436 based on image frames 404 and voxel representation 418. Additionally, an unprojector 414 may generate 3D annotations 416 based on annotations 412. A face determiner 438 may determine faces 440 of 3D annotations 416 based on image frames 404. A sampler 442 may generate points 444 of faces 440 of 3D annotations 416 based on masks 436. Additionally, a position determiner 420 may determine sensor position 422 based on camera/LIDAR/RADAR parameters 408. An occlusion determiner 424 may determine occlusion data 426 based on points 444, voxel representation 418, and sensor position 422.

Point clouds 402 may be the same as, or may be substantially similar to, point clouds 102 of FIG. 1. image frames 404 may be the same as, or may be substantially similar to, image frames 104 of FIG. 1. Camera/LIDAR/RADAR parameters 408 may be the same as, or may be substantially similar to, camera/LIDAR/RADAR parameters 108 of FIG. 1.

Filter 446 may filter various points of point clouds 402 to generate filtered point clouds 448. Filtered point clouds 448 may remove points of point clouds 402 that are associated with an ego system. For example, filter 446 may remove points representative of a system including the cameras that capture image frames 404 and/or the LIDAR/RADAR systems that capture point clouds 402. For instance, a vehicle may include cameras (that capture image frames 404), and a LIDAR system and/or a RADAR system (that capture point clouds 402). Filter 446 may remove from point clouds 402 points that represent the vehicle.

Voxelizer 410 may voxelize filtered point clouds 448 (and/or map data, not illustrated in FIG. 4) to generate voxel representation 418. For example, voxelizer 410 may spatially downsample filtered point clouds 448 to generate voxel representation 418. Voxelizer 410 may be the same as, may be substantially similar to, and/or may perform the same, or substantially the same, operations as voxelizer 110 of FIG. 1. Voxel representation 418 may be the same as, or may be substantially similar to, voxel representation 118 of FIG. 1.

Flow masker 434 may perform an optical-flow analysis of image frames 404 and/or a scene-flow analysis of voxel representation 418 to determine masks 436. For example, flow masker 434 may perform an optical-flow analysis to determine how objects represented by pixels moved between consecutive images of image frames 404. Additionally, flow masker 434 may perform a scene-flow analysis to determine how objects represented by points of voxel representation 418 moved between instances of voxel representation 418 (which instances may be based on instances of point clouds 402).

Flow masker 434 may identify pixel movements that are not consistent with point movements. For example, flow masker 434 may identify objects or points in the scene that move in one way based on the scene-flow analysis of voxel representation 418 and move in another way based on the optical-flow analysis of image frames 404. For instance, the scene-flow analysis may indicate that an object in the scene moves to the right based on an analysis of the object as it appears in instances of voxel representation 418. The optical-flow analysis may indicate that the object moves to the left based on an analysis of the object as it appears in instances of image frames 404. Flow masker 434 may generate masks 436 to indicate such inconsistencies. Such inconsistencies may be indicative of occlusion. For example, the object may be occluded in at least one of the view of the cameras that generated image frames 404 and/or in the view of the LIDAR/RADAR system that generated point clouds 402.

Flow masker 434 may evaluate image-based optical flow and re-project the flow vectors into 3D frustums. Optical flow helps determine regions in 3D where there are annotation/model outputs without any object movement (large buildings or trucks occluding the annotation). Occlusion determiner 424 may evaluate scene flow to evaluate movement of object regions in 3D without any labels. Flow masker 434 may determine an optical flow and/or scene flow for bounding-box corners and pixels/points within the bounding boxes. If the motion of the corners is not consistent with the motion of the pixels/points within the bounding boxes, this indicates an occlusion.

Unprojector 414 may unproject 2D annotations of annotations 412 to generate 3D annotations 416. Annotations 412 may be, or may include, 2D bounding boxes in an image plane indicative of objects detected in image frames 404. Unprojector 414 may unproject the 2D bounding boxes into a 3D space to generate 3D annotations 416. 3D annotations 416 may be, or may include, 3D bounding boxes. Additionally or alternatively, annotations 412 may include 3D bounding boxes.

Annotations 412 may be similar to annotations 112 of FIG. 1. However, whereas annotations 112 includes bounding boxes, polylines, polygons, and/or meshes, annotations 412 may include bounding boxes. For example, system 400 may be a pipeline for handling bounding boxes. Similarly, 3D annotations 416 may be similar to 3D annotations 116 of FIG. 1. However, whereas 3D annotations 116 includes 3D bounding boxes, polylines, polygons, and/or meshes, 3D annotations 416 may include 3D bounding boxes. Unprojector 414 may be the same as, may be substantially similar to, and/or may perform the same, or substantially the same, operations as unprojector 114 of FIG. 1.

Face determiner 438 may determine faces 440 of 3D annotations 416. For example, 3D annotations 416 may include 3D bounding boxes. The 3D bounding boxes may include six faces, including four vertical faces and two horizontal faces. Face determiner 438 may determine which one or two of the vertical faces are visible to the camera that captures image frames 404. For example, the four vertical faces of a 3D bounding box of 3D annotations 416 may face in four different directions (e.g., 90° apart). Face determiner 438 may determine which one or two of the four faces are visible in image frames 404.

For example, face determiner 438 may determine a surface normal of each of the faces of a 3D bounding box of 3D annotations 416. Additionally, face determiner 438 may project (or cast) a ray from sensor position 422 to the center of each of the faces and compare the rays to the surface normals to determine which of the faces are visible in image frames 404. For example, face determiner 438 may determine a dot product between the ray and the face normal. Further, face determiner 438 may apply a threshold on the dot product and decide whether the face is facing the camera or facing the other direction based on the dot product. If it is facing the other direction, then it is behind the object and not facing the camera.

Sampler 442 may generate a number of 3D points 444 on the surface of the faces 440 determined by face determiner 438 to be visible in image frames 404. For example, sampler 442 may oversample faces 440 to generate a number of 3D points 444 on faces 440.

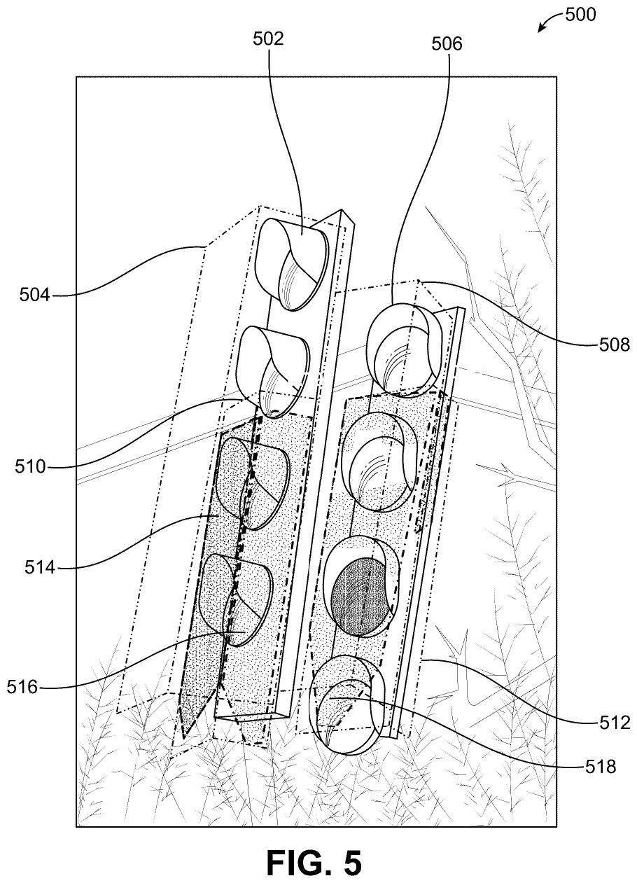

For example, FIG. 5 includes representation of an image 500 of a portion of a scene. Image 500 includes a representation of object 502. Image 500 is overlaid with an annotation of object 502. The annotation is bounding box 504. Bounding box 504 may be determined by an object detector based on image 500. Additionally, image 500 includes a representation of object 506 and bounding box 508 of object 506.

The scene represented by image 500 includes two additional objects not visible (e.g., occluded) in image 500. The two additional objects are annotated by respective bounding boxes. For example, bounding box 510 indicates an object occluded by object 502. Bounding box 510 includes two faces (e.g., face 514 and face 516) that may be identified by face determiner 438 as facing toward the camera that captured image 500. Each of face 514 and face 516 includes a number of points that may be generated by sampler 442.

Similarly, bounding box 512 indicates an object occluded by object 506. Bounding box 512 includes face 518 oriented toward the camera that captured image 500. Face 518 includes a number of points that may be generated by sampler 442.

Returning to FIG. 4, position determiner 420 may determine sensor position 422 based on camera/LIDAR/RADAR parameters 408. Sensor position 422 may represent the position of the camera that captures image frames 404 in the 3D space of voxel representation 418 or the position of the RADAR/LIDAR system that captures point clouds 402. Position determiner 420 may be the same as, may be substantially similar to, and/or may perform the same, or substantially the same, operations as position determiner 120 of FIG. 1. Sensor position 422 may be the same as, or may be substantially similar to, as sensor position 122 of FIG. 1.

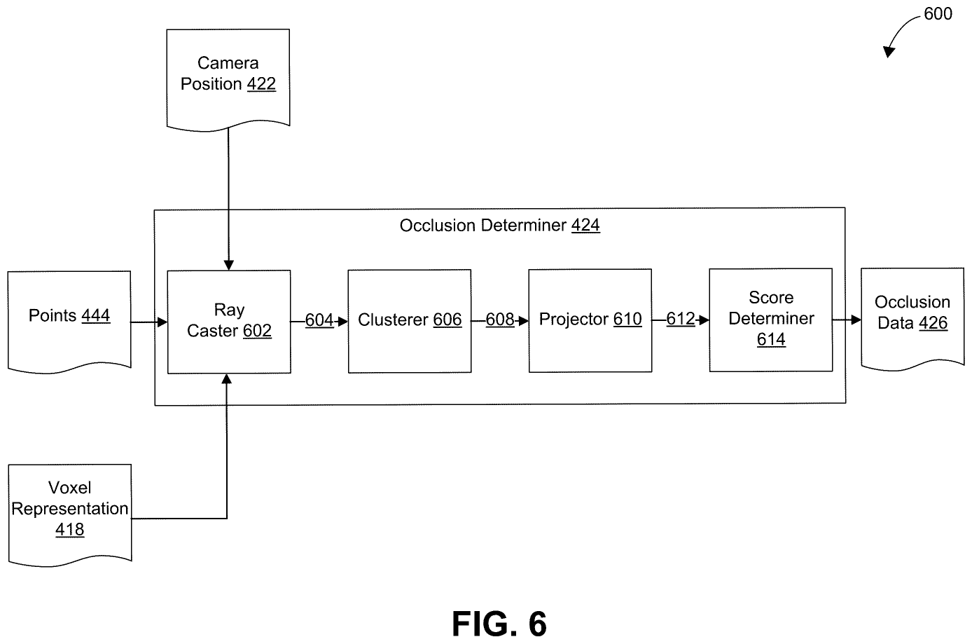

Occlusion determiner 424 may determine occlusion data 426 based on points 444, voxel representation 418, and sensor position 422. Occlusion determiner 424 may be the same as, may be substantially similar to, and/or may perform the same, or substantially the same, operations as occlusion determiner 124 of FIG. 1. Occlusion data 426 may be the same as, or may be substantially similar to, occlusion data 126 of FIG. 1. Additional detail regarding occlusion determiner 424 is provided with regard to FIG. 6.

FIG. 6 is a block diagram illustrating an example implementation of occlusion determiner 424, according to various aspects of the present disclosure. In general, ray caster 602 may project (or cast) rays from sensor position 422 to points 444 of 3D annotations 416 to determine whether the rays intersect occupied voxels of voxel representation 418 or not. Ray caster 602 may determine points 604 indicative of points 444 that are occluded and/or points 444 that are not occluded. Clusterer 606 may cluster points 604 to generate contours 608. Projector 610 may project contours 608 into an image plane to generate 2D points 612. Score determiner 614 may determine occlusion data 426 based on 2D points 612.

Ray caster 602 may project (or cast) rays from sensor position 422 to points 444. Sensor position 422 may represent the point in a 3D space from which image frames 404 are captured.

In many cases, LIDAR and/or RADAR sensors are installed (e.g., on a vehicle) behind cameras (e.g., by approximately 2 meters). This means that if both sensors (a camera and a LIDAR/RADAR sensor) capture representations of the same object, the occlusion of the object in the different representations will be different based on the difference in visibility between the LIDAR/RADAR sensor and the camera. Ray caster 602 may case rays from sensor position 422, which may be determined based on camera/LIDAR/RADAR parameters 408 rather than from a point based on the LIDAR/RADAR sensors.

Points 444 may be points of a face of a 3D bounding box indicative of objects in image frames 404. Voxel representation 418 may include a number of voxels in the 3D space. Some of the voxels may be occupied based on the occupied voxels including points in point clouds 402.

Ray caster 602 may determine occluded rays that intersect occupied voxels between sensor position 422 and occluded points of points 444. For example, ray caster 602 may determine that if a ray between sensor position 422 and a point intersects an occupied voxel between sensor position 422 the point, the ray is an occluded ray, and the point is an occluded point.

Ray caster 602 may determine unoccluded rays that do not intersect any occupied voxels between sensor position 422 and unoccluded points of points 444. For example, ray caster 602 may determine that if a ray between sensor position 422 and a point intersects does not intersect with an occupied voxel between sensor position 422 the point, the ray is an unoccluded ray and the point is an unoccluded point. Ray caster 602 may generate points 604 as an indication of occluded points and/or unoccluded points of points 444.

In some aspects, ray caster 602 may use a configurable tolerance (e.g., 30 simulated centimeters) as a minimum distance between a ray and an occluding voxel. Such a tolerance may avoid errors (e.g., false detections of occlusions) that may result from misplaced bounding boxes and/or self-occlusion.

In some aspects, ray caster 602 may include a filter that may filter ground points from voxel representation 418 based on points 444. For example, ray caster 602 may mark as unoccupied voxels of voxel representation 418 that are occupied by the ground and that may intersect with points 444. For example, ray caster 602 may determine ground voxels of voxel representation 418. Further, ray caster 602 may determine voxels of voxel representation 918 that correspond to points 444. Ray caster 602 may mark as unoccupied any ground voxels of voxel representation 418 that correspond to points of points 444. Additionally or alternatively, ray caster 602 may ignore such ground voxels when determining whether rays intersect with voxels. By marking such voxels as unoccupied (or ignoring such voxels), filter 954 may not determine that a ray intersects with a ground voxel where the ground voxel corresponds to the 3D annotation.

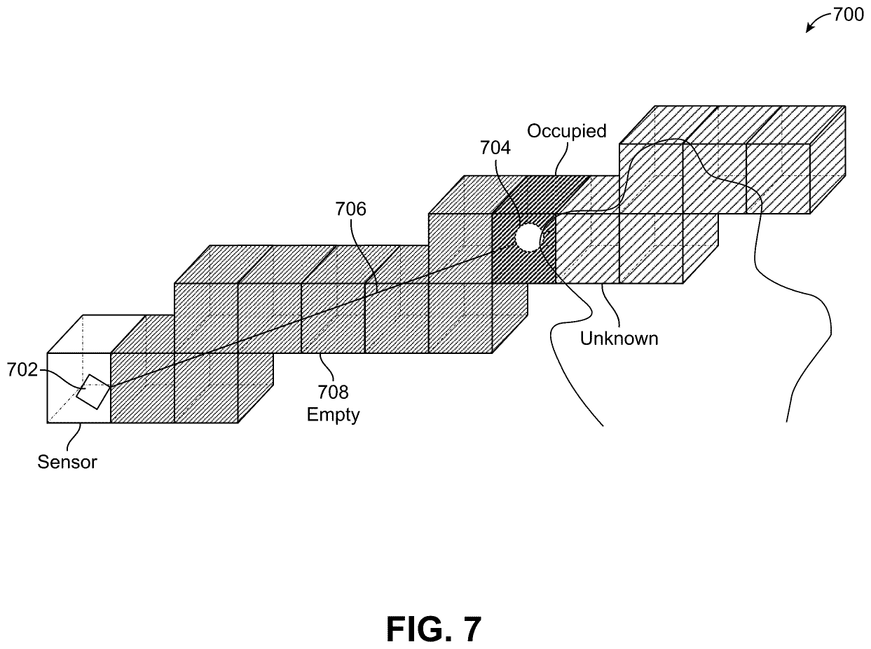

FIG. 7 includes a representation 700 of a ray 706 between a point 702 and a point 704 through a number of unoccupied voxels 708. For example, point 702 may be an example of sensor position 422. Point 704 may be an example of a point of points 444. Ray 706 may be a ray, projected (or cast) by ray caster 602 between point 702 and point 704. The example point 704 illustrated in representation 700 passes through a number of unoccupied voxels 708. Thus, ray caster 602 may determine that ray 706 is unoccluded and that point 704 is unoccluded.

Returning to FIG. 6, clusterer 606 may cluster occluded points and generate contours 608 based on the clusters of occluded points. For example, clusterer 606 may determine clusters of points 444 that are occluded (e.g., based on the indication of points 604). Clusterer 606 may generate contours (e.g., 3D surfaces) based on the clusters of occluded points.

For example, after querying the points on the bounding boxes, points which have been marked as occluded may be combined together to provide a compact representation of occlusion. Clusterer 606 may run a clustering algorithm (such as Density-Based Spatial Clustering of Applications with Noise (DBSCAN)) to cluster points into 3D clusters, where the points belong to a 2D face in 3D space. Further, clusterer 606 may find the outer contour of those clusters and create a polygon out of them. This provides an accurate localized occlusion detection in addition to the ability to compute occlusion percentage by finding area of the occlusion polygon/area of the box faces.

Returning to FIG. 5, object 506 and object 506 are facing the camera that captured image 500 and therefore not occluded. Two objects (e.g., traffic lights) are behind object 502 and object 506 and occluded. The dots (e.g., at face 514, face 516, and face 518) represent the queried points which have been detected as occluded in the various faces of the occluded objects. The polygon (e.g., outlining face 514, face 516, and face 518) is the clustering output which provides a compact representation of occlusion.

Returning to FIG. 6, projector 610 may project the 3D bounding boxes (e.g., of 3D annotations 416) and contours 608 into an image plane. The image plane may correspond to image frames 404. Projector 610 may project the points as 2D points 612.

Score determiner 614 may determine occlusion data 426 based on 2D points 612. For example, score determiner 614 may determine occlusion data 426 for an object in the scene based on the occluded rays between sensor position 422 and points 444 of one or more faces of a 3D annotations 416 corresponding to the object. For instance score determiner 614 may determine occlusion data 426 for a given object as a number of occluded points of the faces divided by a total number of points of the faces.

In some aspects, score determiner 614 may determine occlusion data 426 as, based on, or including, an occlusion percentage. For example, score determiner 614 may determine an occlusion percentage is computed in 3D. Assuming a box with equal width and length, if one face is fully occluded and the other if completely non-occluded, then occlusion percentage would be 50%. However, due to perspective projection and camera distortion, the two faces will not have the same dimensions in 2D.

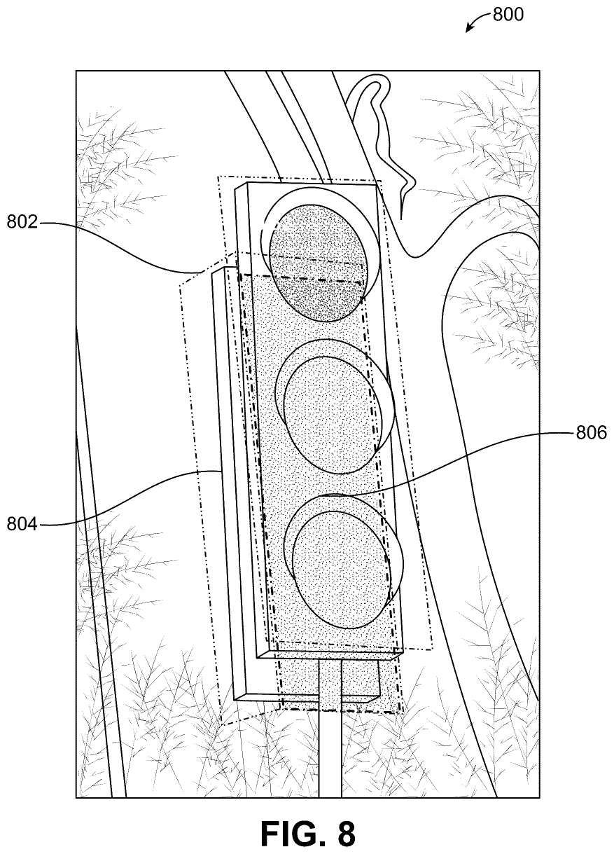

For example, FIG. 8 includes a representation of an image 800 of portion of a scene. The scene represented by image 800 includes an object not visible (e.g., occluded) in image 800. The occluded objects is annotated by bounding box 802. Bounding box 802 includes two faces (e.g., face 804 and face 806) that may be identified by face determiner 438 as facing toward the camera that captured image 800. In image 800, face 804 is smaller than face 806 although in 3D, face 804 and face 806 may have the same dimensions. In image 800, 50% occlusion is not accurate as visualized from the camera.

After finding occlusions in 3D and clustering them into polygons, projector 610 may project the boxes faces and the occlusion polygons to 2D image plane using the camera extrinsics and intrinsics. A polygon in 3D will be represented as a polygon in 2D. Therefore, score determiner 614 may compute the faces area in 2D (e.g., the area of face 804 and face 806 in image 800), compute the occlusion polygon in 2D, and find the occlusion percentage in 2D. In image 800, an occlusion percentage of 62% is more consistent with the visibility from the camera. Both 3D and 2D occlusion percentages can be reported depending on the use-case.

To determine the box face area, score determiner 614 may determine the area of box faces in 3D because sometimes it is needed to detect occlusion for the largest face only when one face is dominating the box, such as traffic signs where the box width is much larger than box length.

Given a 2D box vertical face in 3D space that can rotate across z-axis. Score determiner 614 may determine the area of the 2D face or a polygon representing occlusion on that face. The face points are represented in 3 dimensions. However, using explicit x, y, z values is not possible, because when the face rotates around z, it is unknown which dimensions will contribute to the face area.

Score determiner 614 may principal component analysis (PCA) for every face to reduce dimensionality of the face or polygon to be 2D. Based on the new axes, score determiner 614 may determine the area of the face as area of a rectangle. When the area of an occlusion polygon is determined, score determiner 614 may use PCA to reduce the dimensionality of points representing the polygon to 2D. Then shapely package is used to create a polygon and find its area.

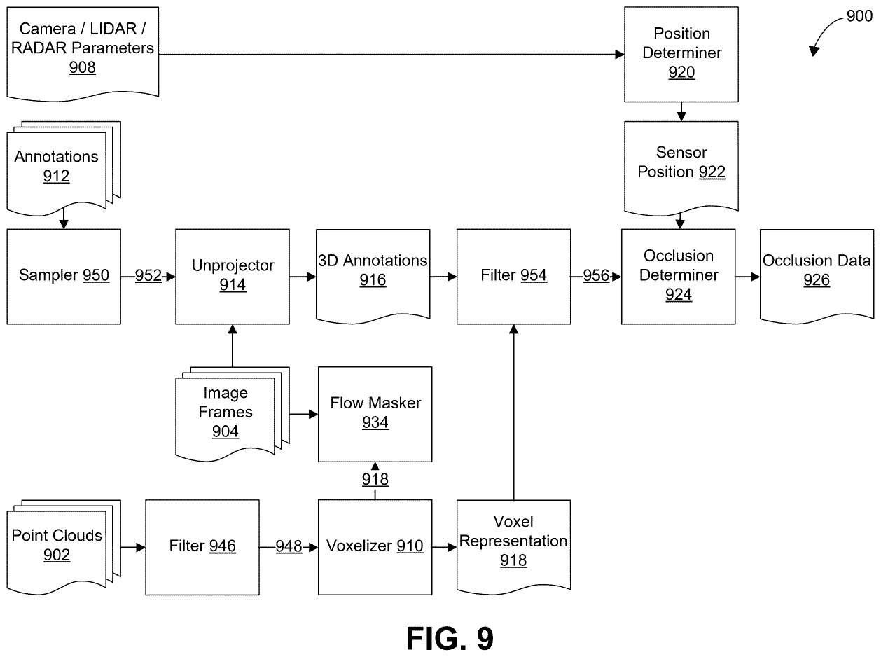

FIG. 9 is a block diagram illustrating an example system 900 for determining occlusions, according to various aspects of the present disclosure. In general, a filter 946 may filter various points of point clouds 902 (which are representative of a scene) to generate filtered point clouds 948. A voxelizer 910 may generate a voxel representation 918 of the scene based on filtered point clouds 948. A flow masker 934 may generate a masks based on image frames 904 and voxel representation 918. Additionally, a sampler 950 may sample (e.g., oversample) annotations 912 to generate oversampled annotations 952. An unprojector 914 may generate 3D annotations 916 based on oversampled annotations 952. A filter 954 may filter points of voxel representation 918 based on 3D annotations 916 to generate voxel representation 956. Additionally, a position determiner 920 may determine sensor position 922 based on camera/LIDAR/RADAR parameters 908. An occlusion determiner 924 may determine occlusion data 926 based on points 944, voxel representation 918, and sensor position 922.

Point clouds 902 may be the same as, or may be substantially similar to, point clouds 102 of FIG. 1. Image frames 904 may be the same as, or may be substantially similar to, image frames 104 of FIG. 1. Camera/LIDAR/RADAR parameters 908 may be the same as, or may be substantially similar to, camera/LIDAR/RADAR parameters 108 of FIG. 1. Filter 946 may be the same as, may be substantially similar to, and/or may perform the same, or substantially the same, operations as filter 446 of FIG. 4. Filtered point clouds 948 may be the same as, or may be substantially similar to, filtered point clouds 448 of FIG. 4. Voxelizer 910 may be the same as, may be substantially similar to, and/or may perform the same, or substantially the same, operations as voxelizer 110 of FIG. 1. Voxel representation 918 may be the same as, or may be substantially similar to, voxel representation 118 of FIG. 1. Flow masker 934 may be the same as, may be substantially similar to, and/or may perform the same, or substantially the same, operations as flow masker 434 of FIG. 4. Position determiner 920 may be the same as, may be substantially similar to, and/or may perform the same, or substantially the same, operations as position determiner 120 of FIG. 1. Sensor position 922 may be the same as, or may be substantially similar to, as sensor position 122 of FIG. 1.

Annotations 912 may be similar to annotations 112 of FIG. 1. However, whereas annotations 112 includes bounding boxes, polylines, polygons, and/or meshes, annotations 912 may include polylines, polygons, and/or meshes. For example, system 900 may be a pipeline for handling polylines, polygons, and/or meshes.

Sampler 950 may sample (e.g., oversample) annotations 912 to generate oversampled annotations 952. Oversampled annotations 952 may include more points to represent objects represented by annotations 912. For example, annotations 912 may include a polyline annotating a lane boundary. The polyline may include points where an angle of the lane line changes. Sampler 950 may add point to the polyline, for example, at a predetermined interval (e.g., every simulated 20 centimeters of 3D space).

Unprojector 914 may unproject oversampled annotations 952 to generate 3D annotations 916. Oversampled annotations 952 may be, or may include, 2D polylines, polygons, and/or meshes in an image plane indicative of objects detected in image frames 904. Unprojector 914 may unproject the 2D polylines, polygons, and/or meshes into a 3D space to generate 3D annotations 916. 3D annotations 916 may be, or may include, 3D polylines, polygons, and/or meshes. 3D annotations 916 may be similar to 3D annotations 116 of FIG. 1. However, whereas 3D annotations 116 includes 3D bounding boxes, polylines, polygons, and/or meshes, 3D annotations 916 may include 3D polylines, polygons, and/or meshes. Unprojector 914 may be the same as, may be substantially similar to, and/or may perform the same, or substantially the same, operations as unprojector 114 of FIG. 1.

Filter 954 may filter ground points from voxel representation 918 based on 3D annotations 916 to generate voxel representation 956. For example, filter 954 may mark as unoccupied voxels of voxel representation 918 that are occupied by the ground and that may intersect with 3D annotations 916. For example, filter 954 may determine ground voxels of voxel representation 918. Further, filter 954 may determine voxels of voxel representation 918 that correspond to points of 3D annotations 916. Filter 954 may mark as unoccupied any ground voxels of voxel representation 918 that correspond to points of 3D annotations 916. By marking such voxels as unoccupied, filter 954 may prevent occlusion determiner 924 from determining that a ray intersects with a ground voxel where the ground voxel corresponds to the 3D annotation.

Occlusion determiner 924 may determine occlusion data 926 based on voxel representation 956 (which may include 3D annotations 916 and voxel representation 918 without ground pixels that correspond to 3D annotations 916). Occlusion determiner 924 similar to occlusion determiner 124 of FIG. 1 and similar to occlusion determiner 424 of FIG. 4 and FIG. 6.

For example, occlusion determiner 924 may project (or cast) rays from sensor position 922 to points of 3D annotations 116 and determine occluded points of the 3D annotations based on whether the projected rays intersect with occupied voxels of the 3D voxel representation.

Additionally, occlusion determiner 924 may cluster occluded points into occluded segments (e.g., segments of polylines) or occluded regions (e.g., regions of polygons or meshes). Occlusion determiner 924 may determine occlusion data 926 based on the occluded segments and/or occluded regions. Occlusion data 926 may be the same as, or may be substantially similar to, occlusion data 126 of FIG. 1.

Occlusion determiner 924 may determine which points of the queried ones are occluded. However the occluded points may be a sparse set of points belonging to each annotation. Occlusion determiner 924 may determine a compact representation of every occlusion segment.

For example, occlusion determiner 924 may run a clustering algorithm such as DBSCAN with predefined parameters to combine occluded points together into clusters. This also helps also filter occlusions based on their lengths depending on the use-cases where in some cases, very small occlusions can be filtered out. Occlusion determiner 924 may generate occlusion data 926 such that occlusion data 926 represents each cluster by start points and/or end points. Such a representation may be a compact and accurate representation of occlusion for polygons/polylines.

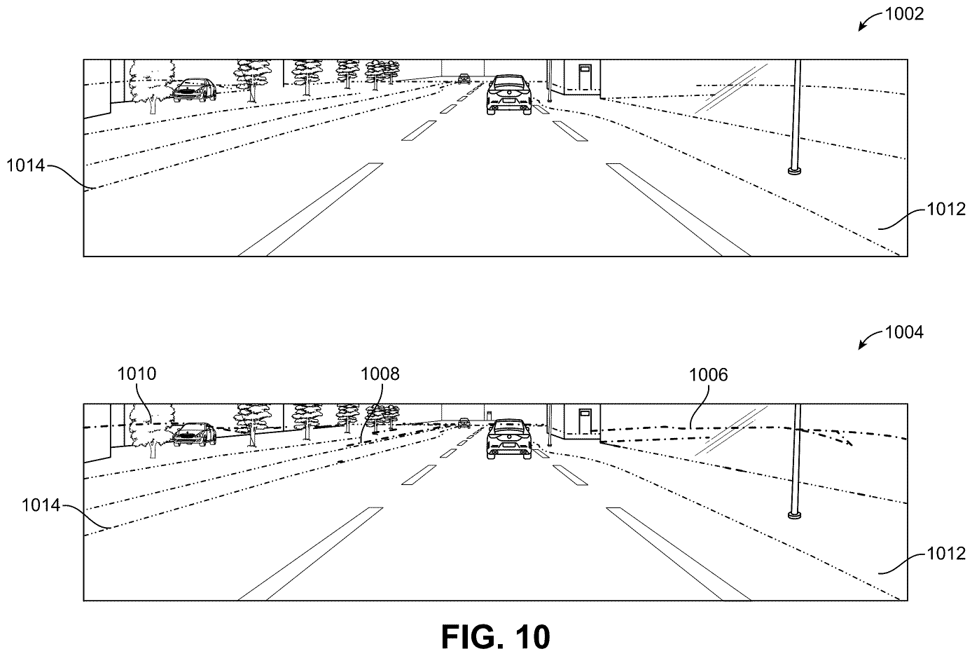

For example, FIG. 10 includes two representations (representation 1002 and representation 1004) of an image of scene. Both representation 1002 and representation 1004 are overlaid with annotations (e.g., polylines). In representation 1002, visible polylines (e.g., unoccluded polylines), for example, polyline 1012 and polyline 1014 are annotated. In representation 1004, visible polylines polyline 1012 and polyline 1014 are annotated. Additionally, in representation 1004, occluded polylines (e.g., polyline 1006, polyline 1008, and polyline 1010) are annotated. The determination of the annotation of the occluded polylines may be based on operations of system 900. Further, the annotations of the occluded polylines may be represented by start and stop points.

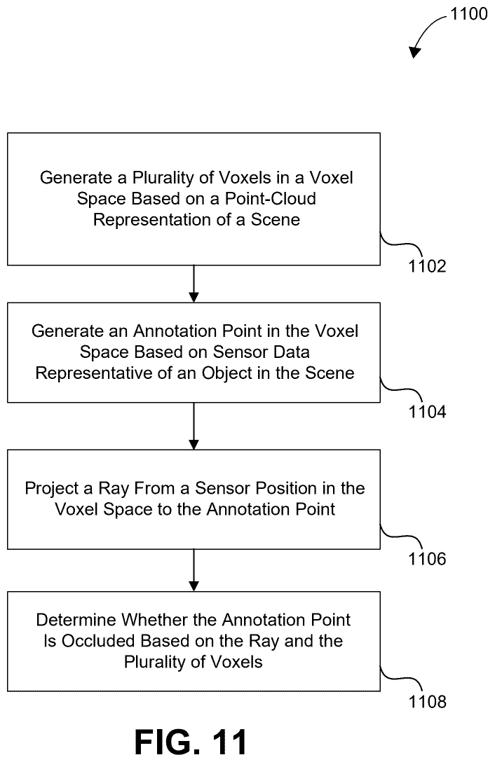

FIG. 11 is a flow diagram illustrating an example process 1100 for occlusion detection, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors.

At block 1102, a computing device (or one or more components thereof) may generate a plurality of voxels in a voxel space based on a point-cloud representation of a scene. For example, voxelizer 110 may generate voxel representation 118 representative of a scene based on point clouds 102 of the scene.

At block 1104, the computing device (or one or more components thereof) may generate an annotation point in the voxel space based on sensor data representative of an object in the scene. For example, voxelizer 110 may generate an annotation point in voxel representation 118 based on 3d annotations 116.

In some aspects, the annotation point is based on at least one of: a bounding box, a polyline, a polygon, or a mesh. For example, 3d annotations 116 may be, or may include, at least one of: a bounding box, a polyline, a polygon, or a mesh. Voxelizer 110 may determine a plurality of annotation points on a surface of a bounding box, polygon, or mesh, or a plurality of annotation points of a polyline.

In some aspects, the computing device (or one or more components thereof) may unproject a two-dimensional annotation indicative of an object in sensor data representative of the scene into the voxel space to generate a three-dimensional annotation in the voxel space; and generate the annotation point in the voxel space based on the three-dimensional annotation. For example, unprojector 114 may unproject annotations 112 to generate 3d annotations 116 and generate the annotation point based on 3d annotations 116.

At block 1106, the computing device (or one or more components thereof) may project a ray from a sensor position in the voxel space to the annotation point. For example, occlusion determiner 124 may project a ray from sensor position 122 to the annotation point.

In some aspects, the computing device (or one or more components thereof) may determine the sensor position in the voxel space based on a relative position of a sensor that captured the sensor data and a point-cloud-capture system that generated the point-cloud representation of the scene. for example, position determiner 120 may determine sensor position 122 based on RADAR parameters 108.

In some aspects, the computing device (or one or more components thereof) may sample a three-dimensional annotation in the voxel space to generate a plurality of annotation points; and project a plurality of rays from the sensor position in the voxel space to the plurality of annotation points. For example, sampler 442 may sample faces 440 to determine points 444. Occlusion determiner 424 may project a ray from sensor position 422 to each of points 444.

At block 1108, the computing device (or one or more components thereof) may determine whether the annotation point is occluded based on the ray and the plurality of voxels. For example, occlusion determiner 124 may determine whether the annotation point is occluded based on the ray projected at block 1106.

In some aspects, to determine whether the annotation point is occluded, the computing device (or one or more components thereof) may determine whether the ray intersects an occupied voxel of the plurality of voxels before arriving at the annotation point. For example, occlusion determiner 124 may determine whether the ray projected at block 1106 intersects an occupied voxel, for example, as described with regard to FIG. 7.

In some aspects, the computing device (or one or more components thereof) may project a plurality of rays from the sensor position in the voxel space to a plurality of corresponding annotation points, wherein the plurality of annotation points are related to the object; identify a plurality of occluded rays of the plurality of rays, wherein each occluded ray of the plurality of occluded rays intersects a respective occupied voxel of the plurality of voxels before reaching a respective annotation point; identify a plurality of unoccluded rays of the plurality of rays, wherein each unoccluded ray of the plurality of occluded rays reaches a respective annotation point without first intersecting an occupied voxel of the plurality of voxels; and determine an occlusion score of the object based on the plurality of occluded rays and the plurality of unoccluded rays.

For example, occlusion determiner 124 may project a ray to each point of a plurality of points of an annotation of an object. Occlusion determiner 124 may determine an occlusion score for the object based on the plurality of rays. for example, occlusion determiner 124 may determine whether each of the plurality of points is occluded or not based on the rays projected to each of the points. For example, occlusion determiner 124 may determine the occlusion score based on a ratio of a count of rays that do not intersect any occupied voxels of voxel representation 118 before reaching annotation point and the total number of rays.

In some aspects, the occlusion score is indicative of a percentage of the object that is represented in the sensor data. For example, the occlusion score may indicate what percentage of the object is visible in the sensor data.

In some aspects, the annotation point is based on a bounding box. The computing device (or one or more components thereof) may determine a face of the bounding box that faces the sensor position; and project a plurality of rays from the sensor position to a corresponding plurality of annotation points of the face of the bounding box. For example, face determiner 438 may determine faces 440 of a bounding box of d annotations 416. Occlusion determiner 424 may project a ray to each of a plurality of points of a face of faces 440.

In some aspects, the computing device (or one or more components thereof) may identify ground voxels from among the plurality of voxels, wherein the ground voxels are excluded from the plurality of voxels in determining whether the annotation point is occluded. for example, filter 446 may determine ground voxels of point clouds 402. The ground voxels may be excluded from voxel representation 418 such that when occlusion determiner 424 determines whether rays intersect occupied voxels, the ground voxels are excluded.

In some aspects, the annotation point is based on a bounding box. The computing device (or one or more components thereof) may determine optical flows for corners of the bounding box; determine optical flows for sensor-data points representative of the object in the sensor data; and determine an occlusion score for the object based on the optical flows for the corners and the optical flows for the sensor-data points. For example, flow masker 434 may determine optical flows of corners of a bounding box and determine optical flows for features of image frames 404. Occlusion determiner 424 may determine the occlusion score based, at least in part, on the optical flows of the corners of the bounding box and the optical flows for the features. For example, when the optical flows of the corners of the bounding box are similar to the optical flows of the features, the occlusion score may be higher than when the optical flows of the corners of the bounding box are dissimilar to the optical flows of the features.

In some aspects, the annotation point is based on a bounding box. The computing device (or one or more components thereof) may determine scene flows for corners of the bounding box; determine scene flows for points of the point-cloud representation of the scene that are representative of the object; and determine an occlusion score for the object further based on the scene flows for the corners and the scene flows for the points. For example, flow masker 434 may determine a scene flows of corners of a bounding box and determine scene flows points of voxel representation 418. Occlusion determiner 424 may determine the occlusion score based, at least in part, on the scene flows of the corners of the bounding box and the scene flows of the points of voxel representation 418. For example, when the scene flows of the corners of the bounding box are similar to the scene flows of the points of voxel representation 418, the occlusion score may be higher than when the scene flows of the corners of the bounding box are dissimilar to the scene flows of the points of voxel representation 418.

In some aspects, the computing device (or one or more components thereof) may adjust a parameter of a perception task based on whether the annotation point is occluded. For example, the computing device (or one or more components thereof) may adjust an operating parameter of three-dimensional object detection (3DOD), traffic-light recognition (TLR), traffic-sign recognition (TSR) detection, lane detection and/or freespace extraction.

In some aspects, the computing device (or one or more components thereof) may adjust an operating parameter of the vehicle based on whether the annotation point is occluded. In some aspects, the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to whether the annotation point is occluded using a user interface of the vehicle.

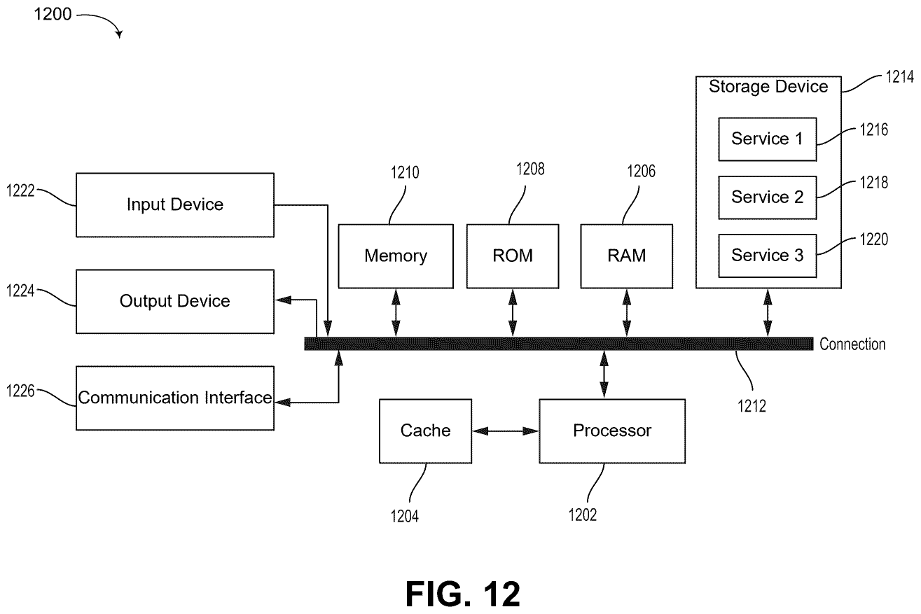

In some examples, as noted previously, the methods described herein (e.g., process 1100 of FIG. 11, and/or other methods described herein) can be performed, in whole or in part, by a computing device or apparatus. In one example, one or more of the methods can be performed by system 100 of FIG. 1, occlusion determiner 124 of FIG. 1, system 300 of FIG. 3, occlusion determiner 324 of FIG. 3, system 400 of FIG. 4, occlusion determiner 424 of FIG. 4 and FIG. 6, system 900 of FIG. 9, occlusion determiner 924 of FIG. 9, or by another system or device. In another example, one or more of the methods (e.g., process 1100, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 100 of FIG. 1, occlusion determiner 124 of FIG. 1, system 300 of FIG. 3, occlusion determiner 324 of FIG. 3, system 400 of FIG. 4, occlusion determiner 424 of FIG. 4 and FIG. 6, system 900 of FIG. 9, and/or occlusion determiner 924 of FIG. 9 and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 100 of FIG. 1, occlusion determiner 124 of FIG. 1, system 300 of FIG. 3, occlusion determiner 324 of FIG. 3, system 400 of FIG. 4, occlusion determiner 424 of FIG. 4 and FIG. 6, system 900 of FIG. 9, occlusion determiner 924 of FIG. 9 and/or other devices, modules, or systems described herein. Additionally or alternatively, computing-device architecture 1200 may be configured to perform process 1100, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for occlusion detection, the apparatus comprising: at least one memory; and at least one processor coupled to the at least one memory and configured to: generate a plurality of voxels in a voxel space based on a point-cloud representation of a scene; generate an annotation point in the voxel space based on sensor data representative of an object in the scene; project a ray from a sensor position in the voxel space to the annotation point; and determine whether the annotation point is occluded based on the ray and the plurality of voxels.

Aspect 2. The apparatus of aspect 1, wherein, to determine whether the annotation point is occluded, the at least one processor is configured to determine whether the ray intersects an occupied voxel of the plurality of voxels before arriving at the annotation point.

Aspect 3. The apparatus of any one of aspects 1 or 2, wherein the annotation point is based on at least one of: a bounding box, a polyline, a polygon, or a mesh.

Aspect 4. The apparatus of any one of aspects 1 to 3, wherein the at least one processor is configured to: unproject a two-dimensional annotation indicative of an object in sensor data representative of the scene into the voxel space to generate a three-dimensional annotation in the voxel space; and generate the annotation point in the voxel space based on the three-dimensional annotation.

Aspect 5. The apparatus of any one of aspects 1 to 4, wherein the at least one processor is configured to determine the sensor position in the voxel space based on a relative position of a sensor that captured the sensor data and a point-cloud-capture system that generated the point-cloud representation of the scene.

Aspect 6. The apparatus of any one of aspects 1 to 5, wherein the at least one processor is configured to: sample a three-dimensional annotation in the voxel space to generate a plurality of annotation points; and project a plurality of rays from the sensor position in the voxel space to the plurality of annotation points.

Aspect 7. The apparatus of any one of aspects 1 to 6, wherein the at least one processor is configured to: project a plurality of rays from the sensor position in the voxel space to a plurality of corresponding annotation points, wherein the plurality of annotation points are related to the object; identify a plurality of occluded rays of the plurality of rays, wherein each occluded ray of the plurality of occluded rays intersects a respective occupied voxel of the plurality of voxels before reaching a respective annotation point; identify a plurality of unoccluded rays of the plurality of rays, wherein each unoccluded ray of the plurality of occluded rays reaches a respective annotation point without first intersecting an occupied voxel of the plurality of voxels; and determine an occlusion score of the object based on the plurality of occluded rays and the plurality of unoccluded rays.

Aspect 8. The apparatus of aspect 7, wherein the occlusion score is indicative of a percentage of the object that is represented in the sensor data.

Aspect 9. The apparatus of any one of aspects 1 to 8, wherein the annotation point is based on a bounding box, and wherein the at least one processor is configured to: determine a face of the bounding box that faces the sensor position; and project a plurality of rays from the sensor position to a corresponding plurality of annotation points of the face of the bounding box.

Aspect 10. The apparatus of any one of aspects 1 to 9, wherein the at least one processor is configured to identify ground voxels from among the plurality of voxels, wherein the ground voxels are excluded from the plurality of voxels in determining whether the annotation point is occluded.

Aspect 11. The apparatus of any one of aspects 1 to 10, wherein the annotation point is based on a bounding box, and wherein the at least one processor is configured to: determine optical flows for corners of the bounding box; determine optical flows for sensor-data points representative of the object in the sensor data; and determine an occlusion score for the object based on the optical flows for the corners and the optical flows for the sensor-data points.

Aspect 12. The apparatus of any one of aspects 1 to 11, wherein the annotation point is based on a bounding box, and wherein the at least one processor is configured to: determine scene flows for corners of the bounding box; determine scene flows for points of the point-cloud representation of the scene that are representative of the object; and determine an occlusion score for the object further based on the scene flows for the corners and the scene flows for the points.

Aspect 13. The apparatus of any one of aspects 1 to 12, wherein the apparatus is configured to adjust a parameter of a perception task based on whether the annotation point is occluded.

Aspect 14. The apparatus of any one of aspects 1 to 13, wherein the apparatus comprises a computing system of a vehicle.

Aspect 15. The apparatus of aspect 14, wherein the apparatus is configured to adjust an operating parameter of the vehicle based on whether the annotation point is occluded.

Aspect 16. The apparatus of aspect 15, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to whether the annotation point is occluded using a user interface of the vehicle.

Aspect 17. A method for occlusion detection, the method comprising: generating a plurality of voxels in a voxel space based on a point-cloud representation of a scene; generating an annotation point in the voxel space based on sensor data representative of an object in the scene; projecting a ray from a sensor position in the voxel space to the annotation point; and determining whether the annotation point is occluded based on the ray and the plurality of voxels.

Aspect 18. The method of aspect 17, wherein, determining whether the annotation point is occluded comprises determining whether the ray intersects an occupied voxel of the plurality of voxels before arriving at the annotation point.

Aspect 19. The method of any one of aspects 17 or 18, wherein the annotation point is based on at least one of: a bounding box, a polyline, a polygon, or a mesh.

Aspect 20. The method of any one of aspects 17 to 19, further comprising: unprojecting a two-dimensional annotation indicative of an object in sensor data representative of the scene into the voxel space to generate a three-dimensional annotation in the voxel space; and generating the annotation point in the voxel space based on the three-dimensional annotation.

Aspect 21. The method of any one of aspects 17 to 20, further comprising determining the sensor position in the voxel space based on a relative position of a sensor that captured the sensor data and a point-cloud-capture system that generated the point-cloud representation of the scene.

Aspect 22. The method of any one of aspects 17 to 21, further comprising: sampling a three-dimensional annotation in the voxel space to generate a plurality of annotation points; and projecting a plurality of rays from the sensor position in the voxel space to the plurality of annotation points.

Aspect 23. The method of any one of aspects 17 to 22, further comprising: projecting a plurality of rays from the sensor position in the voxel space to a plurality of corresponding annotation points, wherein the plurality of annotation points are related to the object; identifying a plurality of occluded rays of the plurality of rays, wherein each occluded ray of the plurality of occluded rays intersects a respective occupied voxel of the plurality of voxels before reaching a respective annotation point; identifying a plurality of unoccluded rays of the plurality of rays, wherein each unoccluded ray of the plurality of occluded rays reaches a respective annotation point without first intersecting an occupied voxel of the plurality of voxels; and determining an occlusion score of the object based on the plurality of occluded rays and the plurality of unoccluded rays.

Aspect 24. The method of aspect 23, wherein the occlusion score is indicative of a percentage of the object that is represented in the sensor data.

Aspect 25. The method of any one of aspects 17 to 24, wherein the annotation point is based on a bounding box, the method further comprising: determining a face of the bounding box that faces the sensor position; and projecting a plurality of rays from the sensor position to a corresponding plurality of annotation points of the face of the bounding box.

Aspect 26. The method of any one of aspects 17 to 25, further comprising identifying ground voxels from among the plurality of voxels, wherein the ground voxels are excluded from the plurality of voxels in determining whether the annotation point is occluded.

Aspect 27. The method of any one of aspects 17 to 26, wherein the annotation point is based on a bounding box, the method further comprising: determining optical flows for corners of the bounding box; determining optical flows for sensor-data points representative of the object in the sensor data; and determining an occlusion score for the object based on the optical flows for the corners and the optical flows for the sensor-data points.

Aspect 28. The method of any one of aspects 17 to 27, wherein the annotation point is based on a bounding box, the method further comprising: determining scene flows for corners of the bounding box; determining scene flows for points of the point-cloud representation of the scene that are representative of the object; and determining an occlusion score for the object further based on the scene flows for the corners and the scene flows for the points.

Aspect 29. The method of any one of aspects 17 to 28, further comprising adjusting a parameter of a perception task based on whether the annotation point is occluded.

Aspect 30. The method of any one of aspects 17 to 29, further comprising adjusting an operating parameter of a vehicle based on whether the annotation point is occluded.

Aspect 31. The method of aspect 30, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to whether the annotation point is occluded using a user interface of the vehicle.

What is claimed is:

1. An apparatus for occlusion detection, the apparatus comprising:
at least one memory; and
at least one processor coupled to the at least one memory and configured to:
generate a plurality of voxels in a voxel space based on a point-cloud representation of a scene;
generate an annotation point in the voxel space based on sensor data representative of an object in the scene;
project a ray from a sensor position in the voxel space to the annotation point; and
determine whether the annotation point is occluded based on the ray and the plurality of voxels.

2. The apparatus of claim 1, wherein, to determine whether the annotation point is occluded, the at least one processor is configured to determine whether the ray intersects an occupied voxel of the plurality of voxels before arriving at the annotation point.

3. The apparatus of claim 1, wherein the annotation point is based on at least one of: a bounding box, a polyline, a polygon, or a mesh.

4. The apparatus of claim 1, wherein the at least one processor is configured to:
unproject a two-dimensional annotation indicative of an object in sensor data representative of the scene into the voxel space to generate a three-dimensional annotation in the voxel space; and
generate the annotation point in the voxel space based on the three-dimensional annotation.

5. The apparatus of claim 1, wherein the at least one processor is configured to determine the sensor position in the voxel space based on a relative position of a sensor that captured the sensor data and a point-cloud-capture system that generated the point-cloud representation of the scene.

6. The apparatus of claim 1, wherein the at least one processor is configured to:
sample a three-dimensional annotation in the voxel space to generate a plurality of annotation points; and
project a plurality of rays from the sensor position in the voxel space to the plurality of annotation points.

7. The apparatus of claim 1, wherein the at least one processor is configured to:
project a plurality of rays from the sensor position in the voxel space to a plurality of corresponding annotation points, wherein the plurality of corresponding annotation points are related to the object;
identify a plurality of occluded rays of the plurality of rays, wherein each occluded ray of the plurality of occluded rays intersects a respective occupied voxel of the plurality of voxels before reaching a respective annotation point;
identify a plurality of unoccluded rays of the plurality of rays, wherein each unoccluded ray of the plurality of occluded rays reaches a respective annotation point without first intersecting an occupied voxel of the plurality of voxels; and
determine an occlusion score of the object based on the plurality of occluded rays and the plurality of unoccluded rays.

8. The apparatus of claim 7, wherein the occlusion score is indicative of a percentage of the object that is represented in the sensor data.

9. The apparatus of claim 1, wherein the annotation point is based on a bounding box, and wherein the at least one processor is configured to:
determine a face of the bounding box that faces the sensor position; and
project a plurality of rays from the sensor position to a corresponding plurality of annotation points of the face of the bounding box.

10. The apparatus of claim 1, wherein the at least one processor is configured to identify ground voxels from among the plurality of voxels, wherein the ground voxels are excluded from the plurality of voxels in determining whether the annotation point is occluded.

11. The apparatus of claim 1, wherein the annotation point is based on a bounding box, and wherein the at least one processor is configured to:
determine optical flows for corners of the bounding box;
determine optical flows for sensor-data points representative of the object in the sensor data; and
determine an occlusion score for the object based on the optical flows for the corners and the optical flows for the sensor-data points.

12. The apparatus of claim 1, wherein the annotation point is based on a bounding box, and wherein the at least one processor is configured to:
determine scene flows for corners of the bounding box;
determine scene flows for points of the point-cloud representation of the scene that are representative of the object; and
determine an occlusion score for the object further based on the scene flows for the corners and the scene flows for the points.

13. The apparatus of claim 1, wherein the apparatus is configured to adjust a parameter of a perception task based on whether the annotation point is occluded.

14. The apparatus of claim 1, wherein the apparatus comprises a computing system of a vehicle.

15. The apparatus of claim 14, wherein the apparatus is configured to adjust an operating parameter of the vehicle based on whether the annotation point is occluded.

16. The apparatus of claim 15, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to whether the annotation point is occluded using a user interface of the vehicle.

17. A method for occlusion detection, the method comprising:
generating a plurality of voxels in a voxel space based on a point-cloud representation of a scene;
generating an annotation point in the voxel space based on sensor data representative of an object in the scene;
projecting a ray from a sensor position in the voxel space to the annotation point; and
determining whether the annotation point is occluded based on the ray and the plurality of voxels.

18. The method of claim 17, wherein, determining whether the annotation point is occluded comprises determining whether the ray intersects an occupied voxel of the plurality of voxels before arriving at the annotation point.

19. The method of claim 17, wherein the annotation point is based on at least one of: a bounding box, a polyline, a polygon, or a mesh.

20. The method of claim 17, further comprising:
unprojecting a two-dimensional annotation indicative of an object in sensor data representative of the scene into the voxel space to generate a three-dimensional annotation in the voxel space; and
generating the annotation point in the voxel space based on the three-dimensional annotation.
